(19) United States
(12) Patent Application Publication
(10) Pub. No.: US 2025/0184351 A1
(43) Pub. Date: Jun. 5, 2025

(54) SYSTEM AND METHOD FOR CREATING VIRTUAL ASSET WALLET ADDRESS DATABASE BASED ON ONLINE HARMFUL SITES

(71) Applicant: BONANZA FACTORY CO., LTD., Seoul (KR)

(72) Inventors: Hye Yeon PARK, Seoul (KR); Han Joo LEE, Seoul (KR); Kyu Hwan JUNG, Seoul (KR); Hyo Yeon JEON, Seoul (KR); Yeon Cheol CHOI, Seoul (KR)

(21) Appl. No.: 19/019,520

(22) Filed: Jan. 14, 2025

Related U.S. Application Data
(63) Continuation of application No. PCT/KR2024/008657, filed on Jun. 23, 2024.

(30) Foreign Application Priority Data
Sep. 14, 2023 (KR) 10-2023-0122300

(51) Int. Cl. H04L 9/40; G06Q 20/36; G06Q 40/04

(52) U.S. Cl. CPC H04L 63/1441; G06Q 20/3678; G06Q 40/04; G06Q 2220/10

(57) ABSTRACT

A system and method for creating a virtual asset wallet address database based on online harmful sites are disclosed. The system includes: a whitelist collection server for generating a whitelist including virtual asset e-wallet addresses by collecting/analyzing transaction data from cryptocurrency trading sites; a whitelist database server for storing the generated whitelist; a crawling server for performing online resource crawling using predetermined keywords on at least one of a surface web, a dark web, or Telegram; a URL/e-wallet address database server for storing URLs/e-wallet addresses of online resources crawled by the crawl server; an online blacklist analysis server for extracting high-risk virtual asset wallet addresses according to specific criteria by analyzing whitelists stored in the whitelist database server and URL/e-wallet addresses stored in the URL/e-wallet address database server, and for generating a main blacklist including the extracted addresses; and a main blacklist database server for storing the generated main blacklist.

### TECHNICAL FIELD

The present disclosure relates to a system and method for creating a virtual asset wallet address database, and more specifically, to a system and method for creating a virtual asset wallet address database based on online harmful sites.

### BACKGROUND ART

Virtual assets based on blockchain are often used in illegal financial transactions due to their inherent characteristic of making fund tracking difficult. When virtual asset wallets are frequently used for highly risky transactions, it is necessary to detect the transactions in advance to prevent fraudulent use.

However, the creation of a virtual asset wallet is very easy and the procedures for security and authentication are lax, so anyone can create a virtual asset wallet at any time and use it for fraudulent purposes.

Therefore, it is necessary to identify highly risky or harmful virtual asset wallets in advance to prevent them from being used in illegal transactions or fraudulent use.

However, current virtual asset exchanges lack measures to prevent this problems.

In particular, considering that many virtual asset wallets are reused for illegal transactions or fraudulent use, there is a need for a means to quickly and accurately identify such illegal virtual asset wallets and monitor transactions thereof.

### DETAILED DESCRIPTION OF INVENTION

### Technical Problems

An object of the present disclosure is to provide a system for creating a virtual asset wallet address database based on online harmful sites.

Another object of the present disclosure is to provide a method for creating a virtual asset wallet address database based on online harmful sites.

### Technical Solution

In one aspect of the present disclosure, a system for creating a virtual asset wallet address database based on online harmful sites includes: a whitelist collection server configured to generate a whitelist consisting of virtual asset e-wallet addresses, which are capable of being traded normally, by collecting and analyzing transaction data from cryptocurrency trading sites; a whitelist database server configured to store the whitelist generated by the whitelist collection server; a crawling server configured to perform online resource crawling using predetermined keywords on at least one of a surface web, a dark web, or Telegram; a URL/e-wallet address database server configured to store URLs/e-wallet addresses of online resources crawled by the crawl server; an online blacklist analysis server configured to extract high-risk virtual asset wallet addresses according to specific criteria by analyzing whitelists stored in the whitelist database server and URL/e-wallet addresses stored in the URL/e-wallet address database server, and to generate a main blacklist consisting of the extracted high-risk virtual asset wallet addresses; a main blacklist database server configured to store the main blacklist generated by the online blacklist analysis server.

Here, the whitelist collection server may include: a dusting module configured to extract a second virtual asset wallet address list of wallet addresses presumed to be held by virtual asset exchanges; an address verification module configured to compare and verify a first virtual asset wallet address list, which corresponds to whitelist candidates extracted through online resource crawling, with a second virtual asset wallet address list extracted by the dusting module and to generate a basic whitelist based on comparison and verification results; a pattern analysis module configured to perform transaction pattern analysis on the basic whitelist generated by the address verification module and, based on an analysis result, generate a scale-up whitelist presumed to consist of wallet addresses belonging to the virtual asset exchanges; and a clustering module configured to generate a final whitelist by clustering a plurality of virtual asset wallet addresses corresponding to the scaled-up whitelist generated by the pattern analysis module.

Furthermore, the whitelist database server may include a whitelist database in which the generated final whitelist is stored.

Furthermore, the crawling server may include: a search module configured to perform online resource crawling using predetermined keywords to search for online resources where high-risk wallet addresses are used; an update module configured to automatically update the online resources searched by the search module; an address extraction module configured to extract addresses of the online resources updated by the update module; and a cryptocurrency-related URL/keyword database configured to store URLs and keywords corresponding to the online resources extracted by the address extraction module.

Furthermore, the URL/e-wallet address database server may include: a URL/e-wallet address database server configured to store the URLs and e-wallet addresses corresponding to the online resources extracted by the address extraction module.

Furthermore, the online blacklist analysis server may include: a DB linkage module configured to interlink final whitelists stored in the whitelist database and URLs and e-wallet addresses stored in the URL/e-wallet address database; a clustering linkage module configured to interlink the final whitelists clustered and stored in the whitelist database with the URLs and e-wallet addresses stored in the URL/e-wallet address database; and a risky address determination module configured to extract high-risk virtual asset wallet addresses based on linkage results of the DB linkage module and the clustering linkage module, and to generate a main blacklist consisting of the extracted high-risk virtual asset wallet addresses.

Furthermore, the main blacklist database server may include a main blacklist database in which the main blacklist generated by the risky address determination module is stored.

In another aspect of the present disclosure, a method for creating a virtual asset wallet address database based on online harmful sites includes: generating, by a whitelist collection server, a whitelist consisting of virtual asset e-wallet addresses, which are capable of being traded normally, by collecting and analyzing transaction data from cryptocurrency trading sites; storing, at a whitelist database server, the whitelist generated by the whitelist collection server; performing, by a crawling server, online resource crawling using predetermined keywords on at least one of a surface web, a dark web, or Telegram; storing, by a URL/e-wallet address database server, corresponding URL/e-wallet address by online resource crawling performed by the crawl server; extracting, by an online blacklist analysis server, high-risk virtual asset wallet addresses according to specific criteria by analyzing whitelists stored in the whitelist database server and URL/e-wallet addresses stored in the URL/e-wallet address database server, and then generating a main blacklist consisting of the extracted high-risk virtual asset wallet addresses; and storing, by a main blacklist database server, the main blacklist generated by the online blacklist analysis server.

Here, the generating, by the whitelist collection server, of a whitelist consisting of virtual asset e-wallet addresses, which are capable of being traded normally, by collecting and analyzing of transaction data from cryptocurrency trading sites may include: extracting, by a dusting module, a second virtual asset wallet address list of wallet addresses presumed to be held by virtual asset exchanges; comparing and verifying, by an address verification module, a first virtual asset wallet address list, which corresponds to whitelist candidates extracted through online resource crawling, with the second virtual asset wallet address list extracted by the dusting module, and then generating a basic whitelist based on comparison and verification results; performing, by a pattern analysis module, transaction pattern analysis on the basic whitelist generated by the address verification module and, based on an analysis result, generating a scale-up whitelist presumed to consist of wallet addresses belonging to the virtual asset exchanges; and generating, by a clustering module, a final whitelist by clustering a plurality of virtual asset wallet addresses corresponding to the scaled-up whitelist generated by the pattern analysis module.

Furthermore, the performing, by the crawling server, of online resource crawling using predetermined keywords for at least one of a surface web, a dark web, and Telegram may include: performing, by a search module, online resource crawling using predetermined keywords to search for online resources where high-risk wallet addresses are used; automatically updating, by an update module, the online resources searched by the search module; extracting, by an address extraction module, addresses of the online resources updated by the update module; and storing, by a cryptocurrency-related URL/keyword database, URLs and keywords corresponding to the online resources extracted by the address extraction module.

### Effect of Invention

According to the system and method for creating a virtual asset wallet address database based on the above-described online harmful site, it is configured to build a database by creating a whitelist and blacklist of virtual asset wallets for each virtual asset through crawling online resources, thereby creating a database for virtual asset wallet addresses. This has the effect of quickly filtering and monitoring illegal use and fraudulent transactions.

### BRIEF DESCRIPTION OF THE DRAWING

FIG. 1 is a block diagram of a system for creating a virtual asset wallet address database based on online harmful sites according to an embodiment of the present disclosure.

FIG. 2 is a diagram illustrating the detailed configuration of a system for creating a virtual asset wallet address database based on online harmful sites according to an embodiment of the present disclosure.

FIG. 3 is a flowchart illustrating a method for creating a virtual asset wallet address database based on online harmful sites according to an embodiment of the present disclosure.

FIGS. 4 to 7 is a flowchart illustrating detailed steps of a method for creating a virtual asset wallet address database based on online harmful sites according to an embodiment of the present disclosure.

### BEST MODE FOR CARRYING OUT THE INVENTION

Various modifications may be made to exemplary embodiments of the present disclosure, and specific exemplary embodiments will be described below in detail with reference to attached drawings. However, it should be understood that the present disclosure is not to be limited to the specific embodiments, but includes all modifications, equivalents, and alternatives falling within the spirit and scope of the disclosure. The like reference numerals are used for similar components in describing each of the drawings.

It will be understood that, although the terms “first”, “second”, “A”, “B”, and the like may be used herein in explaining various components of the present disclosure, such components should not be limited by these terms. The above terms are only used to distinguish one component from another. For example, without departing from the scope of the present disclosure, a first component may be referred to as a second component, and similarly, the second component may also be referred to as the first component. The expression “and/or” encompasses any one of a combination of a plurality of associated items as described, and a plurality of associate items as described.

When a component is referred to as being “connected” or “accessed” to other component, it should be understood that not only is the component directly connected or accessed to the other component, but also, another component may exist therebetween. On the other hand, when a component is referred to as being “directly connected” or “directly accessed” to other component, it should be understood that there is no component therebetween.

The terms used in this application are only used to describe specific embodiments and are not intended to limit the present disclosure. The singular forms are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, preferred embodiments according to the present disclosure will be described in detail with reference to the attached drawings.

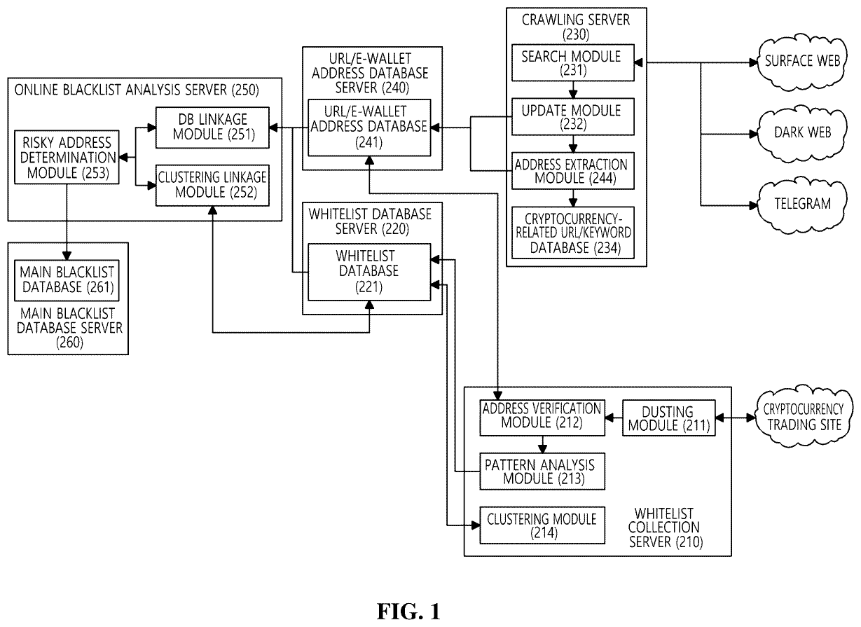

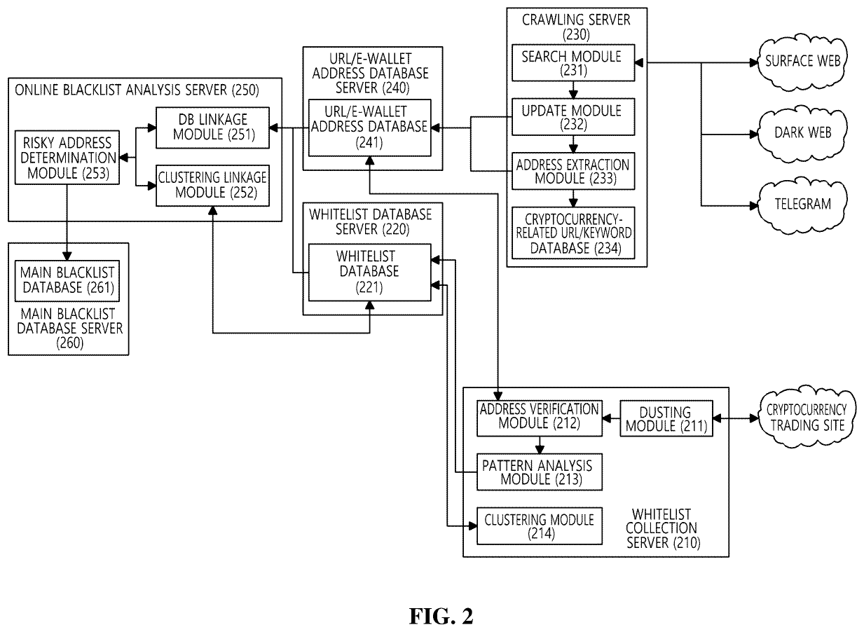

FIG. 1 is a block diagram of a system for creating a virtual asset wallet address database based on online harmful sites according to an embodiment of the present disclosure, and FIG. 2 is a diagram illustrating the detailed configuration of a system for creating a virtual asset wallet address database based on online harmful sites according to an embodiment of the present disclosure.

Referring to the drawings, a system 200 for creating a virtual asset wallet address database based on online harmful sites according to an embodiment of the present disclosure may include a whitelist collection server 210, a whitelist database server 220, a crawling server 230, a URL/e-wallet address database server 240, an online blacklist analysis server 250, and a main blacklist database server 260.

Hereinafter, the detailed configuration will be described.

The whitelist collection server 210 may be configured to generate a whitelist consisting of virtual asset e-wallet addresses capable of being traded normally, by collecting and analyzing transaction data from cryptocurrency trading sites.

The whitelist collection server 210 may include a dusting module 211, an address verification module 212, a pattern analysis module 213, and a clustering module 214.

Hereinafter, the detailed configuration will be described.

The dusting module 211 may be configured to extract a second virtual asset wallet address list of wallet addresses presumed to be held by virtual asset exchanges.

The address verification module 212 may be configured to compare and verify a first virtual asset wallet address list, which corresponds to whitelist candidates extracted through online resource crawling, with a second virtual asset wallet address list extracted by the dusting module 211, and to generate a basic whitelist based on comparison and verification results.

The pattern analysis module 213 may be configured to perform transaction pattern analysis on the basic whitelist generated by the address verification module 212 and, based on an analysis result, generate a scaled-up whitelist that is presumed to consist of wallet addresses belonging to virtual asset exchanges.

The clustering module 214 may be configured to generate a final whitelist by clustering a plurality of virtual asset wallet addresses corresponding to the scaled-up whitelist generated by the pattern analysis module 213.

The whitelist database server 220 may include a URL/e-wallet address database 221 where the whitelist generated by the whitelist collection server 210 is stored.

The crawling server 230 may be configured to perform online resources crawling using predetermined keywords on at least one of a surface web, a dark web, or Telegram.

The crawling server 230 may include a search module 231, an update module 232, an address extraction module 233, and a cryptocurrency-related URL/keyword database 234.

Hereinafter, the detailed configuration will be described.

The search module 231 may be configured to perform online resource crawling using predetermined keywords to search for online resources where high-risk wallet addresses are used.

The update module 232 may be configured to automatically update the online resources searched by the search module 231.

The address extraction module 233 may be configured to extract addresses of the online resources updated by the update module 232.

The cryptocurrency-related URL/keyword database 234 may be configured to store URLs and keywords corresponding to the online resources extracted by the address extraction module 233.

The URL/e-wallet address database server 240 may include a whitelist database 241 where the corresponding URLs/e-wallet addresses are stored by the online resource crawling performed by the crawling server 230.

The online blacklist analysis server 250 may be configured to extract high-risk virtual asset wallet addresses according to specific criteria by analyzing whitelists stored in the whitelist database server 220 and URL/e-wallet addresses stored in the URL/e-wallet address database server 240, and to generate a main blacklist consisting of the extracted high-risk virtual asset wallet addresses.

The online blacklist analysis server 250 may include a DB linkage module 251, a clustering linkage module 252, and a risky address determination module 253.

Hereinafter, the detailed configuration will be described.

The DB linkage module 251 may be configured to interlink final whitelists stored in the whitelist database 221 and URLs and wallet addresses stored in the URL/e-wallet address database 241.

The clustering linkage module 252 may be configured to interlink the final whitelists clustered and stored in the whitelist database 221 with the URLs and wallet addresses stored in the URL/e-wallet address database 241.

The risky address determination module 253 may be configured to extract high-risk virtual asset wallet addresses based on linkage results of the DB linkage module 251 and the clustering linkage module 252 and to generate a main blacklist consisting of the extracted high-risk virtual asset wallet addresses.

The main blacklist database server 260 may include a main blacklist database 261 where the main blacklist generated by the online blacklist analysis server 250 is stored.

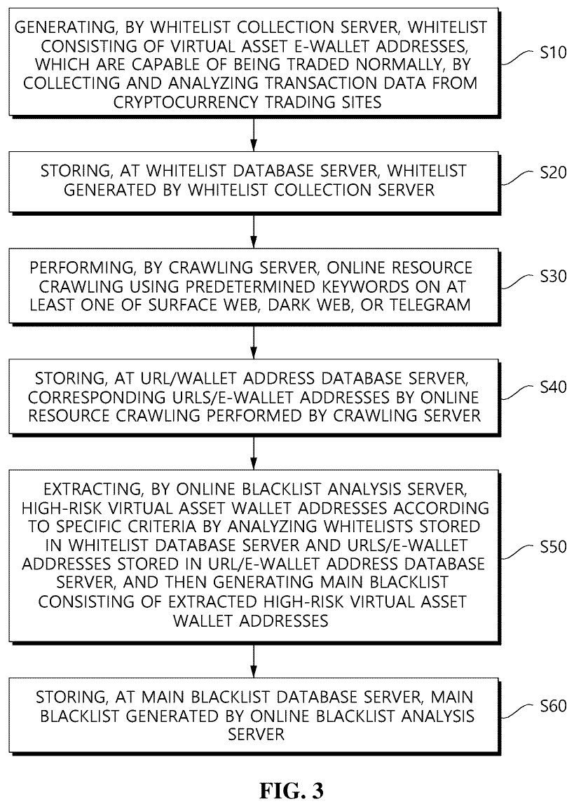

FIG. 3 is a flowchart illustrating a method for creating a virtual asset wallet address database based on online harmful sites according to an embodiment of the present disclosure.

Referring to FIG. 3, a whitelist collection server 210 generates a whitelist consisting of virtual asset e-wallet addresses, which are capable of being traded normally, by collecting and analyzing transaction data from cryptocurrency trading sites (S10). The details are as follows.

First, a dusting module 211 extracts a second virtual asset wallet address list of wallet addresses presumed to be held by virtual asset exchanges. Then, an address verification module compares and verifies the first virtual asset wallet address list, which corresponds to whitelist candidates already extracted through online resource crawling, with the second virtual asset wallet address list extracted by the dusting module 211, and then generates a basic whitelist based on comparison and verification results. Then, a pattern analysis module 213 performs transaction pattern analysis on the basic whitelist generated by the address verification module 212 and, based on an analysis result, generates a scaled-up whitelist that is presumed to consist of wallet addresses belonging to virtual asset exchanges. Then, a clustering module 214 generates a final whitelist by clustering a plurality of virtual asset wallet addresses corresponding to the scaled-up whitelist generated by the pattern analysis module 213.

Next, a whitelist generated by the whitelist collection server is stored in a whitelist database server 220 (S20).

Next, a crawling server performs online resource crawling using predetermined keywords on at least one of a surface web, a dark web, or Telegram (S30). The details are as follows.

First, a search module 231 performs online resource crawling using predetermined keywords to search for online resources where high-risk wallet addresses are used. Then, an update module 232 automatically updates the online resources searched by the search module 231. Then, an address extraction module 233 extracts addresses of the online resources updated by the update module 232. Then, a cryptocurrency-related URL/keyword database 234 stores URLs and keywords corresponding to the online resources extracted by the address extraction module 233.

Next, a URL/e-wallet address database server 240 stores the corresponding URLs/e-wallet addresses by online resource crawling performed by the crawling server 230 (S40).

Next, an online blacklist analysis server 250 extracts high-risk virtual asset wallet addresses according to specific criteria by analyzing whitelists stored in the whitelist database server 220 and URLs/e-wallet addresses stored in the URL/e-wallet address database server 240, and then generates a main blacklist consisting of the extracted high-risk virtual asset wallet addresses (S50).

Next, the main blacklist generated by the online blacklist analysis server 250 is stored in a main blacklist database server 260 (S60).

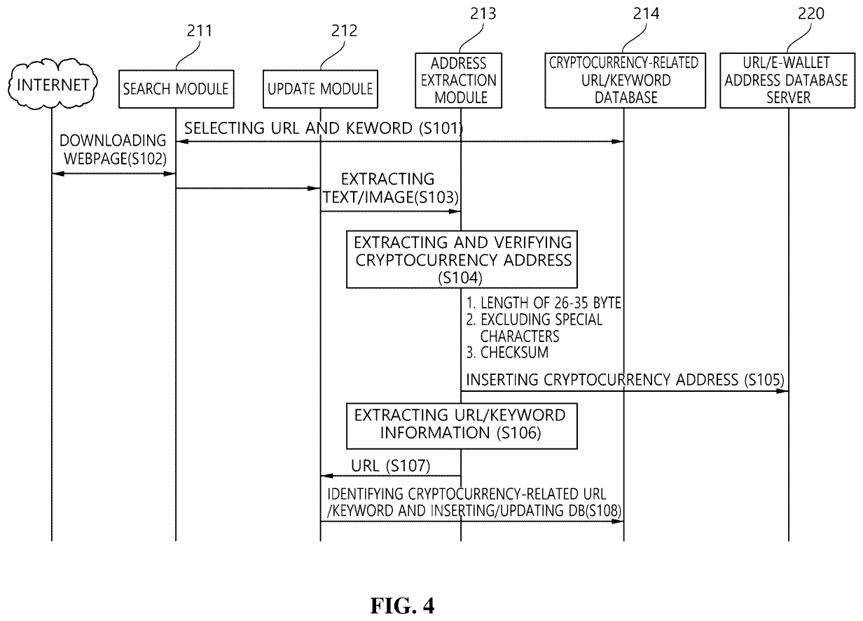

FIGS. 4 to 7 is a flowchart illustrating detailed steps of a method for creating a virtual asset wallet address database based on online harmful sites according to an embodiment of the present disclosure.

Referring to FIG. 4, the detailed steps for online resource crawling for generating a blacklist by a crawling server 230 are illustrated. A search module 211 is configured to select a URL and a keyword to download a web page, and an address extraction module 213 is configured to extract and verify a cryptocurrency address for collection.

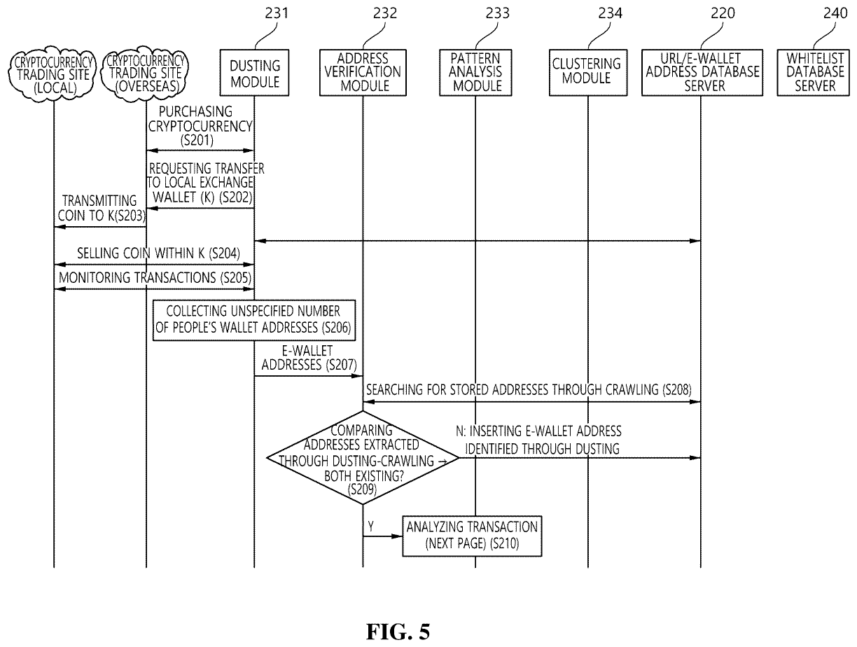

FIG. 5 illustrates the detailed process of a whitelist collecting operation.

Referring to FIG. 5, a detailed process in which a dusting module 231 collects an unspecified number of people's wallet addresses through dusting and stores the collected wallet addresses is shown.

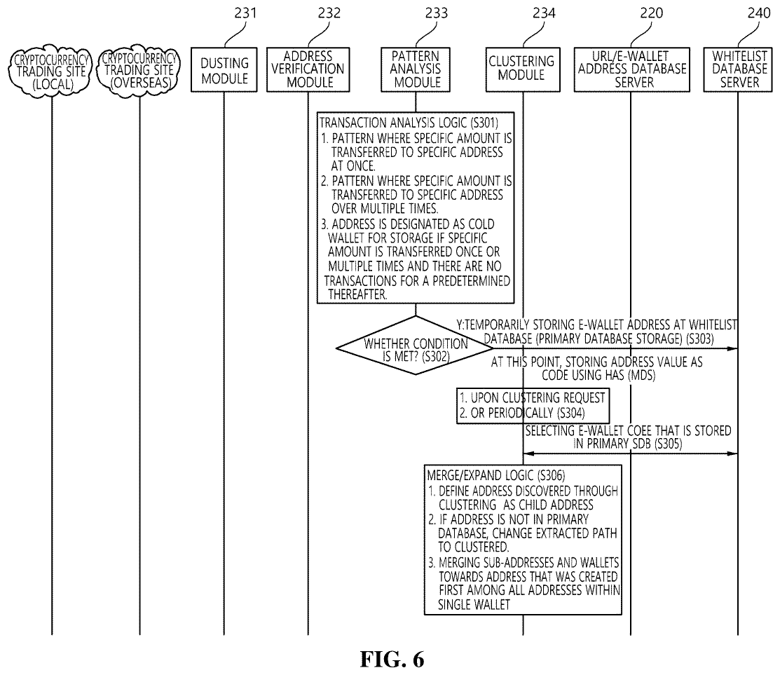

Referring to FIG. 6, the detailed steps of performing transaction pattern analysis on the wallet addresses collected through dusting and storing wallet addresses meeting a specific condition in a whitelist. At this point, if a specific amount or more is transferred to a specific address at once or over multiple times, the specific address is stored in the whitelist.

In addition, it is configured to define upper and lower addresses by merging or expanding wallet addresses through clustering.

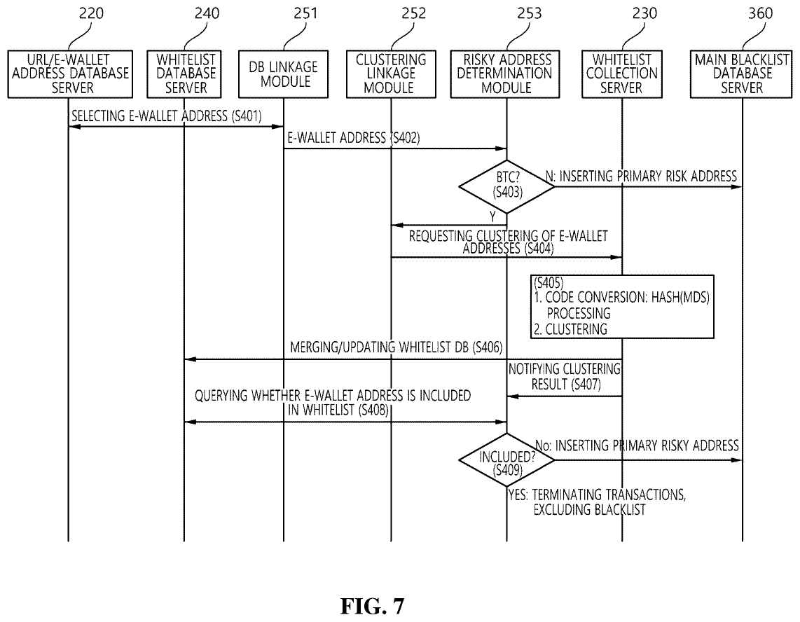

Meanwhile, FIG. 7 illustrates detailed steps of analysis by an online blacklist analysis server 250. Referring to FIG. 7, it is configured to determine whether an address is risky by using DB linkage and clustering linkage of the previously generated whitelist and blacklist.

As described above, the present disclosure is configured to build a database by generating whitelists and blacklists of virtual asset wallets through online resource crawling, thereby enabling the rapid filtering and monitoring of illegal use and fraudulent transactions concerning virtual asset wallet addresses.

Although the description has been made with reference to the above examples, those skilled in the art can understand that various modifications and changes can be made to the present disclosure without departing from the spirit and scope of the present disclosure as set forth in the claims below.

1. A system for creating a virtual asset wallet address database based on online harmful sites, the system comprising:
a whitelist collection server configured to generate a whitelist consisting of virtual asset e-wallet addresses, which are capable of being traded normally, by collecting and analyzing transaction data from cryptocurrency trading sites;
a whitelist database server configured to store the whitelist generated by the whitelist collection server;
a crawling server configured to perform online resource crawling using predetermined keywords on at least one of a surface web, a dark web, or Telegram;
a URL/e-wallet address database server configured to store URLs/e-wallet addresses of online resources crawled by the crawl server;
an online blacklist analysis server configured to extract high-risk virtual asset wallet addresses according to specific criteria by analyzing whitelists stored in the whitelist database server and URL/e-wallet addresses stored in the URL/e-wallet address database server, and to generate a main blacklist consisting of the extracted high-risk virtual asset wallet addresses; and
a main blacklist database server configured to store the main blacklist generated by the online blacklist analysis server.

2. The method of claim 1, wherein the whitelist collection server comprises:
a dusting module configured to extract a second virtual asset wallet address list of wallet addresses presumed to be held by virtual asset exchanges;
an address verification module configured to compare and verify a first virtual asset wallet address list, which corresponds to whitelist candidates extracted through online resource crawling, with a second virtual asset wallet address list extracted by the dusting module and to generate a basic whitelist based on comparison and verification results;
a pattern analysis module configured to perform transaction pattern analysis on the basic whitelist generated by the address verification module and, based on an analysis result, generate a scale-up whitelist presumed to consist of wallet addresses belonging to the virtual asset exchanges; and
a clustering module configured to generate a final whitelist by clustering a plurality of virtual asset wallet addresses corresponding to the scaled-up whitelist generated by the pattern analysis module.

3. The method of claim 2, wherein the whitelist database server comprises a whitelist database in which the generated final whitelist is stored.

4. The method of claim 3, wherein the crawling server comprises:
a search module configured to perform online resource crawling using predetermined keywords to search for online resources where high-risk wallet addresses are used;
an update module configured to automatically update the online resources searched by the search module;
an address extraction module configured to extract addresses of the online resources updated by the update module; and
a cryptocurrency-related URL/keyword database configured to store URLs and keywords corresponding to the online resources extracted by the address extraction module.

5. The method of claim 4, wherein the URL/e-wallet address database server comprises a URL/e-wallet address database server configured to store the URLs and e-wallet addresses corresponding to the online resources extracted by the address extraction module.

6. The method of claim 4, wherein the online blacklist analysis server comprises:
a DB linkage module configured to interlink final whitelists stored in the whitelist database and URLs and e-wallet addresses stored in the URL/e-wallet address database;
a clustering linkage module configured to interlink the final whitelists clustered and stored in the whitelist database with the URLs and e-wallet addresses stored in the URL/e-wallet address database; and
a risky address determination module configured to extract high-risk virtual asset wallet addresses based on linkage results of the DB linkage module and the clustering linkage module, and to generate a main blacklist consisting of the extracted high-risk virtual asset wallet addresses.

7. The method of claim 6, wherein the main blacklist database comprises a main blacklist database in which the main blacklist generated by the risky address determination module is stored.

8. A method for creating a virtual asset wallet address database based on online harmful sites, the method comprising:
generating, by a whitelist collection server, a whitelist consisting of virtual asset e-wallet addresses, which are capable of being traded normally, by collecting and analyzing transaction data from cryptocurrency trading sites;
storing, at a whitelist database server, the whitelist generated by the whitelist collection server;
performing, by a crawling server, online resource crawling using predetermined keywords on at least one of a surface web, a dark web, or Telegram;
storing, by a URL/e-wallet address database server, corresponding URL/e-wallet address by online resource crawling performed by the crawl server;
extracting, by an online blacklist analysis server, high-risk virtual asset wallet addresses according to specific criteria by analyzing whitelists stored in the whitelist database server and URL/e-wallet addresses stored in the URL/e-wallet address database server, and then generating a main blacklist consisting of the extracted high-risk virtual asset wallet addresses; and
storing, by a main blacklist database server, the main blacklist generated by the online blacklist analysis server.

9. The method of claim 8, wherein the generating, by the whitelist collection server, of a whitelist consisting of virtual asset e-wallet addresses, which are capable of being traded normally, by collecting and analyzing of transaction data from cryptocurrency trading sites comprises:
extracting, by a dusting module, a second virtual asset wallet address list of wallet addresses presumed to be held by virtual asset exchanges;
comparing and verifying, by an address verification module, a first virtual asset wallet address list, which corresponds to whitelist candidates extracted through online resource crawling, with the second virtual asset wallet address list extracted by the dusting module, and then generating a basic whitelist based on comparison and verification results;
performing, by a pattern analysis module, transaction pattern analysis on the basic whitelist generated by the address verification module and, based on an analysis result, generating a scale-up whitelist presumed to consist of wallet addresses belonging to the virtual asset exchanges; and
generating, by a clustering module, a final whitelist by clustering a plurality of virtual asset wallet addresses corresponding to the scaled-up whitelist generated by the pattern analysis module.

10. The method of claim 9, wherein the performing, by the crawling server, of online resource crawling using predetermined keywords for at least one of a surface web, a dark web, and Telegram comprises:
performing, by a search module, online resource crawling using predetermined keywords to search for online resources where high-risk wallet addresses are used;
automatically updating, by an update module, the online resources searched by the search module;
extracting, by an address extraction module, addresses of the online resources updated by the update module; and
storing, by a cryptocurrency-related URL/keyword database, URLs and keywords corresponding to the online resources extracted by the address extraction module.
